(19) United States
(12) Patent Application Publication
(10) Pub. No.: US 2026/0268103 A1
(43) Pub. Date: Sep. 10, 2026

(54) OPTICAL BARCODE READING SYSTEM

(71) Applicant: CHUNG-HAO HSU, Taipei City (TW)

(72) Inventor: CHUNG-HAO HSU, Taipei City (TW)

(21) Appl. No.: 19/558,428

(22) Filed: Mar. 5, 2026

(30) Foreign Application Priority Data
Mar. 5, 2025 (TW) 114108122

(51) Int. Cl. G06K 7/14

(52) U.S. Cl. CPC G06K 7/1413

(57) ABSTRACT

An optical barcode reading system, wherein a light emitting device emits a light coding signal to a coding area, and the optical barcode reading system is used to read the light coding signal, the optical barcode reading system comprising an image module, wherein the image module captures an image of the coding area and the image module analyzes the image to generate a coding data; a positioning module, wherein the positioning module obtains a positioning data according to a position of the optical barcode reading system; and a processing module, wherein the processing module is respectively connected electrically to the image module and the positioning module; wherein the processing module outputs a data corresponding to the coding data and the positioning data.

### BACKGROUND OF THE INVENTION

### Technical Field

The present invention is generally related to an optical barcode, and more particularly to an optical barcode reading system.

### Description of Related Art

Barcodes have been widely used in various fields. Currently, a lot of information is transmitted through barcodes. Taking one-dimensional barcodes as an example, one-dimensional barcodes are composed of lines and spaces of varying widths, which are arranged through specific coding rules to form a set of identification codes. One-dimensional barcodes have the advantages of easy reading and fast processing speed.

However, the number of characters that can be placed in a general barcode is limited, which restricts the amount of information that can be transmitted will be limited, and there are still inconveniences during use. Therefore, the conventional barcode reading system still needs to be improved.

### BRIEF SUMMARY OF THE INVENTION

In view of the above, the primary objective of the present invention is to provide an optical barcode reading system that can effectively increase the amount of information transmitted within a limited number of characters.

The present invention provides an optical barcode reading system, wherein a light emitting device emits a light coding signal to a coding area, and the optical barcode reading system is used to read the light coding signal, the optical barcode reading system comprising an image module, wherein the image module captures an image of the coding area and the image module analyzes the image to generate a coding data; a positioning module, wherein the positioning module obtains a positioning data according to a position of the optical barcode reading system; and a processing module, wherein the processing module is respectively connected electrically to the image module and the positioning module; wherein the processing module outputs a data corresponding to the coding data and the positioning data.

The optical barcode reading system can effectively increase the amount of information transmitted by outputting the corresponding data through the coding data and the positioning data. For example, when the light emitting device is arranged in a first exhibition area, and another light emitting device is arranged in a second exhibition area, the light emitting device arranged in the first exhibition area and the other light emitting device arranged in the second exhibition area can emit the same light coding signal, when the illumination barcode reading system reads the light coding signal in the first exhibition area, the positioning module can obtain a positioning data, and the processing module can output the data corresponding to the coding data and the positioning data, and when the illumination barcode reading system reads the light coding signal in the second exhibition area, the positioning module can obtain the other positioning data, and the processing module can output the other data corresponding to the coding data and the other positioning data. Thus, the processing module can output two different data through the same optical coding signal in combination with two different positioning data, thereby achieving the effect of increasing the amount of information transmitted.

### BRIEF DESCRIPTION OF THE SEVERAL VIEWS OF THE DRAWINGS

The present invention would be best understood by referring to the following detailed description of some illustrative embodiments in conjunction with the accompanying drawings, in which

FIG. 1 is a block diagram of a preferred embodiment of the present invention;

FIG. 2 is a schematic diagram of the optical barcode reading system of the preferred embodiment of the present invention in use.

### DETAILED DESCRIPTION OF THE INVENTION

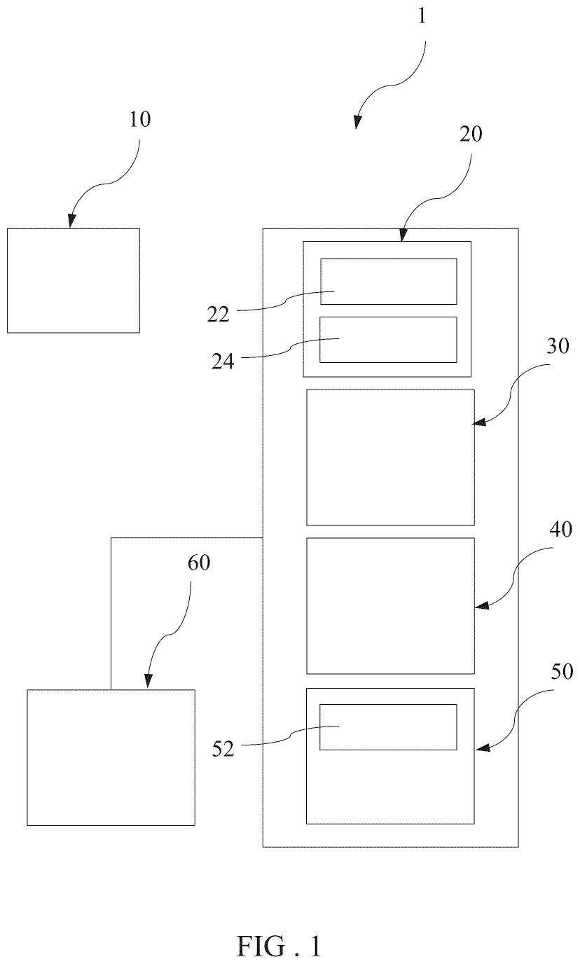

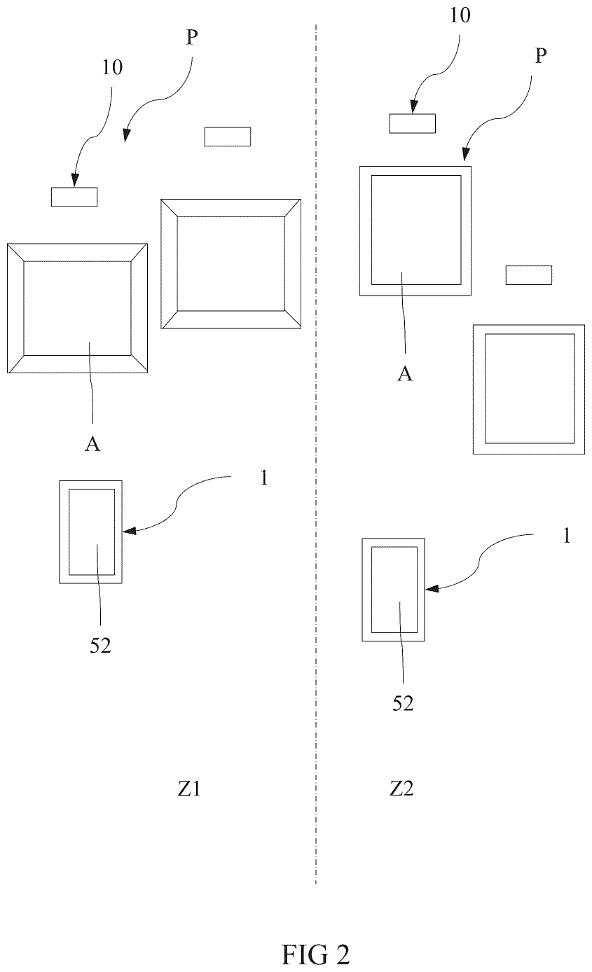

Please refer to FIG. 1 to FIG. 2, which shows an optical barcode reading system 1 of a preferred embodiment of the present invention. A light emitting device 10 emits a light coding signal to a coding area A, and the optical barcode reading system 1 is used to read the light coding signal. The light emitting device 10 may be LED for lighting and emitting the light coding signal. For example, optical camera communications (OCC) technology may be used to enable the light emitting device 10 to emit coded flashing light to emit the light coding signal.

The optical barcode reading system 1 includes an imaging module 20, a positioning module 30 and a processing module 40. The processing module 40 is electrically connected to the image module 20 and the positioning module 30 respectively. The positioning module 30 obtains a positioning data according to the position of the optical barcode reading system 1. The imaging module 20 captures the image of the coding area A and analyzes the image to generate a coding data, the coding data includes a plurality of coding groups, and the processing module 40 outputs the data corresponding to each of the coding groups in the coding data and the positioning data. The imaging module 20 includes a camera 22 for capturing the image of the coding area A within a time interval when the light emitting device 10 is in operation, wherein the image of the coding area A includes a plurality of images; the imaging module 20 includes a decoding unit 24, and the decoding unit 24 is used to process the plurality of images to obtain, for example, the width of bright lines and dark lines, and then complete the decoding to obtain each of the coding groups and generate the coding data.

In this embodiment, the positioning module 30 can be, for example, a Bluetooth module, a Global Positioning System, or a Wi-Fi positioning module. Thus, the processing module 40 can output two different data through the same optical coding signal in combination with two different positioning data, thereby achieving the effect of increasing the amount of information transmitted.

In this embodiment, the optical barcode reading system 1 includes a display module 50, which may include a display screen 52. The display module 50 displays the data, whereby the processing module 40 can output the data for the user to read on the display screen 52.

In the present embodiment, the optical barcode reading system 1 includes a database 60 connected electrically to the processing module 40. The database 60 stores the data and a map data. The map data includes a first area and a second area. The processing module 40 compares the positioning data and the map data. When the positioning data is located in the first area, the data output by the processing module 40 corresponding to the coding data and the positioning data is the first data. When the positioning data is located in the second area, the data output by the processing module 40 corresponding to the coding data and the positioning data is the second data.

For example, the first area and the second area of the map data correspond to a first exhibition area Z1 and a second exhibition area Z2 in a gallery. As shown in FIG. 2, the gallery is provided with a plurality of paintings P and a plurality of light emitting devices 10 at the first exhibition area Z1 and the second exhibition area Z2. Each of the light emitting devices 10 is provided corresponding to the position of each painting P to illuminate each painting, and the light emitting devices 10 provided in the first exhibition area Z1 emit different light coding signals from each other. The light emitting devices 10 disposed in the second zone Z2 emit different light coding signals, but the light emitting devices 10 disposed in the first zone Z1 and the second zone Z2 may use the same light coding signal. For example, one of the light emitting devices 10 in the first zone Z1 may emit the same light coding signal as one of the light emitting devices 10 in the second zone Z2.

Thus, when the user is in the first exhibition area Z1, the optical barcode reading system can be used to read the light coding signal on a painting in the first exhibition area Z1. The processing module 40 compares the positioning data with the map data to obtain that the positioning data is located in the first area, and outputs the first data corresponding to the coding data and the positioning data. The first data can be related introduction information corresponding to the painting. When the user is in the first exhibition area but moves to another painting, the optical barcode reading system 1 can also be used to read a light coding signal on another painting in the first exhibition area Z1. The processing module 40 compares the positioning data with the map data, and obtains that the positioning data is located in the first area, and outputs another first data corresponding to the coding data and the positioning data. The other first data can be the relevant introduction information corresponding to the other painting.

When the user moves to the second exhibition area Z2, the optical barcode reading system 1 can be used to read a light coding signal on a painting in the second exhibition area Z2. The processing module 40 compares the positioning data with the map data, and obtains that the positioning data is located in the second area, and outputs the second data corresponding to the coding data and the positioning data. The second data can be related introduction information corresponding to the painting. When the user moves to another painting in the second exhibition area, the optical barcode reading system 1 can also be used to read a light coding signal on the other painting in the second exhibition area. The processing module 40 compares the positioning data with the map data, and obtains that the positioning data is located in the second area, and outputs another second data corresponding to the coding data and the positioning data. The another second data can be relevant introduction information corresponding to the other painting.

In summary, the effect of the present invention is that when the light emitting device 10 is arranged in the first exhibition area Z1 and another light emitting device is arranged in the second exhibition area Z2, the light emitting devices 10 arranged in the first exhibition area Z1 and the second exhibition area Z2 can emit the same light coding signal, and when the illumination type barcode reading system 1 reads the light coding signal in the first exhibition area Z1, the positioning module 30 can obtain the positioning data. The processing module 40 can output the data corresponding to the coding data and the positioning data. When the optical barcode reading system 1 reads a optical coding signal in the second exhibition area Z2, the positioning module 30 can obtain another positioning data. Through the processing module, the processing module can output another data corresponding to the coding data and another positioning data. In this way, the same optical coding signal can output two different data by coordinating with two different positioning data, thereby achieving the effect of increasing the amount of information transmitted.

It must be pointed out that the embodiments described above are only some preferred embodiments of the present invention. All equivalent structures which employ the concepts disclosed in this specification and the appended claims should fall within the scope of the present invention.

What is claimed is:

1. An optical barcode reading system, wherein a light emitting device emits a light coding signal to a coding area, and the optical barcode reading system is used to read the light coding signal, the optical barcode reading system comprising:
an image module, wherein the image module captures an image of the coding area and the image module analyzes the image to generate a coding data;
a positioning module, wherein the positioning module obtains a positioning data according to a position of the optical barcode reading system; and
a processing module, wherein the processing module is respectively connected electrically to the image module and the positioning module; wherein the processing module outputs a data corresponding to the coding data and the positioning data.

2. The optical barcode reading system as claimed in claim 1, further includes a database, wherein the database connected electrically to the processing module, wherein the database stores a map data, and the map data includes a first area and a second area, wherein the processing module compares the positioning data with the map data; wherein when the positioning data is located in the first area, the processing module outputs the data corresponding to the coding data and the positioning data, and the data is defined as a first data;
wherein when the positioning data is located in the second area, the processing module outputs the data corresponding to the coding data and the positioning data, and the data is defined as a second data.

3. The optical barcode reading system as claimed in claim 1, further includes a display module, wherein the display module displays the data.

4. The optical barcode reading system as claimed in claim 1, wherein the positioning module is a Bluetooth module, a Global Positioning System or a Wi-Fi positioning module.

5. The optical barcode reading system as claimed in claim 1, further includes a database, wherein the database connected electrically to the processing module; wherein the database stores the data.

6. The optical barcode reading system as claimed in claim 1, wherein the coding data includes a plurality of coding groups, and the processing module outputs the data corresponding to each coding group in the coding data and the positioning data.
